(19) United States
(12) Patent Application Publication
(10) Pub. No.: US 2010/0185631 A1
(43) Pub. Date: Jul. 22, 2010

(54) TECHNIQUES FOR DATA AGGREGATION, ANALYSIS, AND DISTRIBUTION

(75) Inventors: Nicholas Van Caldwell, Bellevue, WA (US); Ravi Shahani, Redmond, WA (US); Kevin Roland Powell, Kirkland, WA (US); Jonathan Ludwig, Tolland, CT (US); Courtney Anne O'keef, Bellevue, WA (US); Phan Huy Tu, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/355,806

(22) Filed: Jan. 19, 2009

(51) Int. Cl. G06F 17/30

(52) U.S. Cl. 707/756; 707/E17.006; 707/E17.044

(57) ABSTRACT

Various technologies and techniques are disclosed for aggregating and using data collected from multiple computers to modify a later behavior of those computers. In one implementation, a data aggregation system is described. A data collector is operable to collect behavior data over a network from one or more applications used by the computers, and to save the behavior data to a data store. A data installer is operable to access the behavior data in the data store and convert the behavior data into a format that will modify a future operation of at least one of the applications that is used on at least one of the computers. A method for creating and distributing a custom dictionary from data collected from multiple computers is described. A method for identifying related documents from data collected from multiple computers is also described.

### BACKGROUND

The computers that are used by people in a company are typically connected to a server and/or one other over a network. The way that each person in a company uses his/her computer could provide valuable information for others in the organization. Unfortunately, a lot of business knowledge that can be inferred and shared by monitoring the computer activities of users within the company gets lost each day.

### SUMMARY

Various technologies and techniques are disclosed for aggregating and using data collected from multiple computers to modify a later behavior of those computers. In one implementation, a data aggregation system is described. A data collector is operable to collect behavior data over a network from one or more applications used by the computers, and to save the behavior data to a data store. A data installer is operable to access the behavior data in the data store and convert the behavior data into a format that will modify a future operation of at least one of the applications that is used on at least one of the computers.

In one implementation, a method for creating and distributing a custom dictionary is described. Term data is received from computers over a network. The term data includes terms that have been collected from applications running on the computers. The term data that was received from the computers is analyzed to determine which terms should be marked for distribution to the computers. The terms marked for distribution are sent to at least one of the computers for inclusion in a custom dictionary that is used by one or more of the applications.

In another implementation, a method for identifying related documents is described. Document correlation data is received from a plurality of computers over a network. The document correlation data includes information about documents that are opened at similar points in time. Alternatively or additionally, the document correlation data can include information about documents that are referenced together in an email or other document. The document correlation data that was received from the computers is then analyzed to create a database of related documents. A query request is received from one of the computers over the network. The query request contains a request for any documents that are related to a particular document. In response to the query request, result information is returned regarding one or more documents that are contained in the database of related documents that were previously determined to be related to the particular document.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a data aggregation system of one implementation.

FIG. 2 is a diagrammatic view of a data aggregation system of another implementation.

FIG. 3 is a process flow diagram for one implementation illustrating the stages involved in creating and distributing a custom dictionary.

FIG. 4 is a diagrammatic view of a custom dictionary distribution system of one implementation.

FIG. 5 is a process flow diagram for one implementation illustrating the stages involved in collecting and distributing related document data.

FIG. 6 is a diagrammatic view of a related document distribution system of one implementation.

FIG. 7 is a diagrammatic view of a distributed update system of one implementation.

FIG. 8 is a diagrammatic view of a computer system of one implementation.

### DETAILED DESCRIPTION

The technologies and techniques herein may be described in the general context as a framework for collecting behavior data from computers over a network and then using the behavior data to alter the operation of those computers, but the technologies and techniques also serve other purposes in addition to these. In one implementation, one or more of the techniques described herein can be implemented as features within a content management application such as MICROSOFT® Office SharePoint Server, or from any other type of program or service that monitors the behavior of one or more computers or that utilizes the behavior data that has been collected from multiple computers.

In one implementation, behavior data is collected from computers over a network, such as an intranet. The term “behavior data” as used herein is meant to include data that is related to actions that happen while a computer is being used, such as what files are opened around the same time, what content actually gets typed into the programs that are open, and so on. Once that behavior data is collected from multiple computers over a network, the behavior data can be analyzed in the aggregate and used to determine interesting updates to make to the client computers.

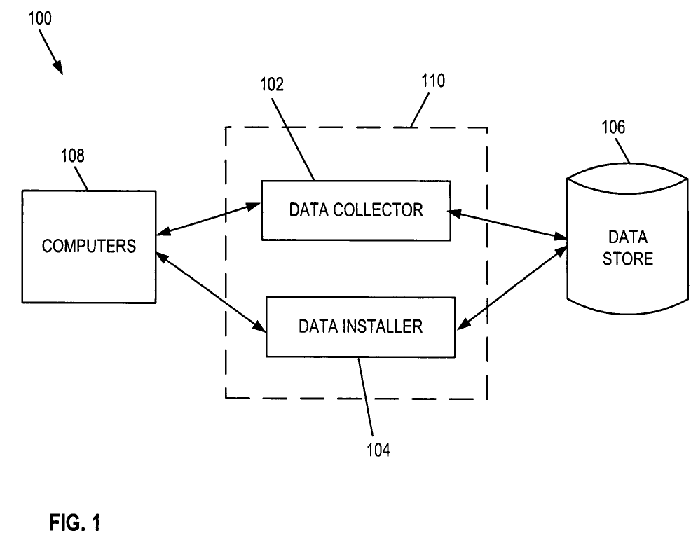

As one non-limiting example, a custom dictionary can be created and then propagated back down to the computers on the network after analyzing the behavior data to create or revise the custom dictionary. In such a scenario, the behavior data can be in the form of “term data”, which includes terms that are used by end users within documents. For example, term data can include commonly used words, entries from the user's custom lexicon, words that were ignored, etc. As another non-limiting example, documents that have been determined to be related to each other upon collecting data from multiple computers can be shared with other computers in the network. These are just a few examples of how the aggregated behavior data can be used to then update other computers in the network. Turning now to FIGS. 1-8, these concepts will be described in detail.

FIG. 1 is a diagrammatic view of a data aggregation and distribution system 100 of one implementation. Data aggregation system 100 includes at least one data collector 102, at least one data installer 104, and at least one data store 106. Data store 106 can be included in one or more separate databases, and/or data store 106 can just be data that is stored as part of data collector 102 and/or data installer 104. In one implementation, data collector 102 and data installer 104 are managed by a data manager 110, where data manager 110 interfaces with data store 106.

In one implementation, data collector 102 resides on a server and is connected with computers 108 over a network, such as an Intranet, the Internet, or another network. When data collector 102 is contained on a server, data collector is responsible from collecting behavior data from multiple computers 108 that participate in the network, and then storing the collected behavior data in data store 106. In other implementations, a separate data collector 102 can be installed on each of computers 108, with each data collector 102 then being responsible for recording the data to the data store 106. Data that is collected by each data collector 102 is stored in data store 106 with unique IDs that allow the data to be retrieved later.

One non-limiting example of behavior data that can be collected by data collector 102 includes what files are opened around the same time. If users tend to open a word processing document at the same time as a spreadsheet, then that gives a good indication that these documents may be related or have some other connection to one another. Another non-limiting example of behavior data includes what content actually gets typed into the programs that are open. For example, if an email or word processing document frequently includes hyperlinks or embedded attachments to the certain documents or resources together, then there is a good chance that those documents are related.

Another non-limiting example of behavior data that could be gathered by data collector 102 includes the words that get typed into a word processing or other document that are flagged as incorrect by a proofing tool and then indicated as “correct” by the user. Examples of proofing tools can include a grammar checker, contextual spell checker, etc. When the user indicates that the something is correct, is incorrect, does nothing, etc., this information can be useful. For example, it could evidence a company-specific or industry standard term that may not appear in a general dictionary. These are just a few non-limiting examples to illustrate the types of behavior data that could be collected by data collector 102 from computers 108. Any other actions that can be monitored and collected from computers 108 for use (such as in the aggregate or on an individual user basis) could also be gathered by data collector 102.

When gathered in the aggregate from multiple computers 108 over a network, this behavior data can be used for various scenarios to provide enhanced functionality to some or all of the computers 108 participating in the network. Data collector 102 is responsible for analyzing the behavior data contained in the data store 106. Data installer 104 then converts the behavior data into a format that will modify a future operation of at least one of the applications on one or more of computers 108. For example, this can include creating data for a custom dictionary, making recommendations on documents that are related to one another, providing a list of related people (like on a same team), distributing content and/or application updates, and so on.

In another implementation, behavior data can be collected over one network for use as a training set. The result of the analysis of the training data can then be used to alter the operation of one or more computers on another network (that is separate from the network on which the data was collected).

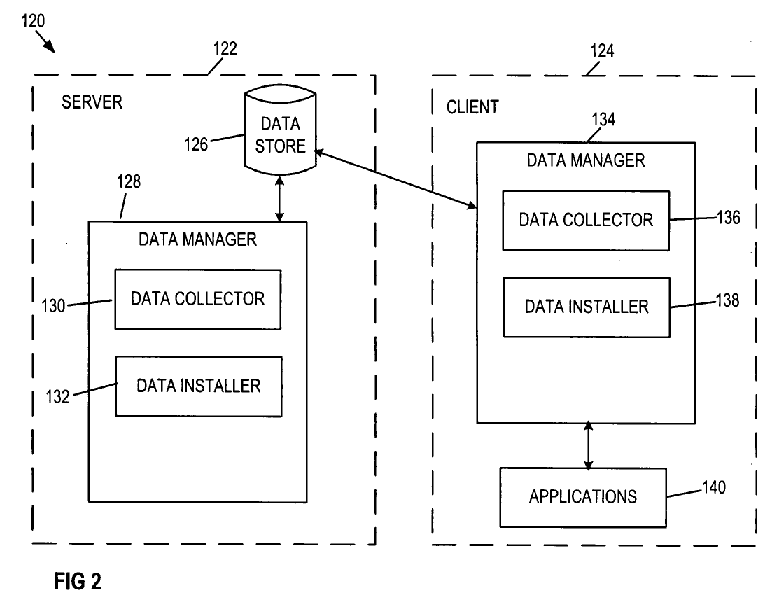

Various usage examples are described in further detail in FIGS. 2-7, which are discussed next.

One of ordinary skill in the computer art will appreciate that data collector 102 and/or data installer 104 can be located on one of many varying computers and/or arrangements and still perform some or all of the techniques described herein. For example, data collector 102 and/or data installer 104 can be located on one or more client computers, server computers, and/or both.

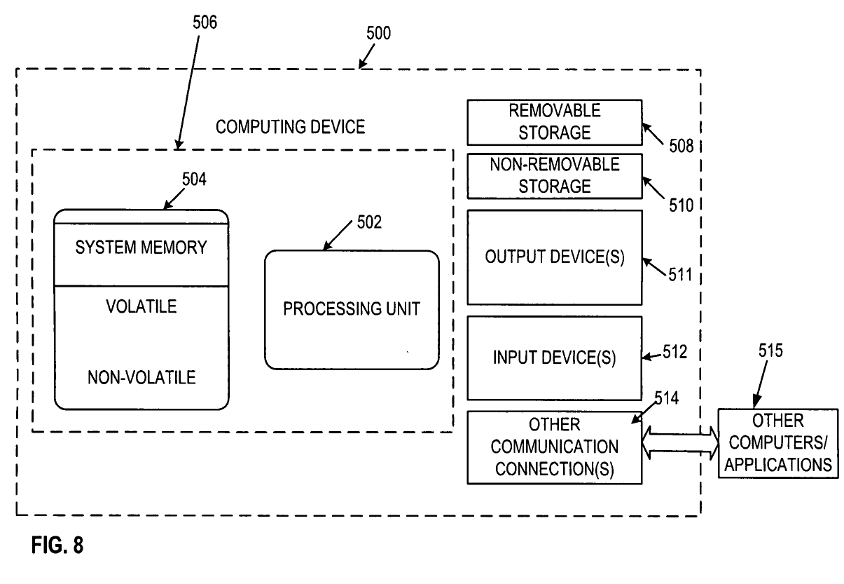

Turning now to FIGS. 2-7, stages and/or techniques for implementing one or more implementations of data aggregation and distribution system 100 are described in further detail. In some implementations, the processes and/or techniques of FIG. 2-7 are at least partially implemented in the operating logic of computing device 500 (of FIG. 8).

FIG. 2 is a diagrammatic view 120 of a data aggregation and distribution system of another implementation. In this example, there is a server computer 122 and a client computer 124. Server computer 122 contains a data manager 128 with a data collector 130 and a data installer 132, and client computer 124 contains a data manager 134 with a data collector 136 and a data installer 138. Server computer also contains a data store 126 that is accessible by both server computer 122 and by client computer 124. Although just one client computer 124 is shown, there can be multiple client computers in other implementations.

In this example, behavior data gets collected from both the server side and the client side (by data collectors 130 and 136, respectively). For example, behavior data can be captured by data collector 130 from the way that users interact with one or more programs that run on the server computer 122, such as browser-based applications. Then, on the client computer 124, the data collector 136 can collect behavior data from applications 140 that are running locally on the machine, such as a word processor, spreadsheet, etc.

In the example shown, the data installers (132 and 138, respectively) are each responsible for accessing data store 126 and making use of the aggregated data on the respective computer. In the case of the server computer 122, data installer 132 is responsible for creating or modifying the operation of one or more programs that run on the server computer 122, such as a web application. On client computer 124, the data installer 138 is responsible for modifying the operation of one of more of applications 140 based upon the aggregated data that was retrieved from the data store 126. As noted in the discussion of FIG. 1, there are various other combinations of data collectors, data installers, and/or client and server arrangements that can be used. Some specific examples will now be used to illustrate the concepts introduced in FIGS. 1 and 2 in further detail.

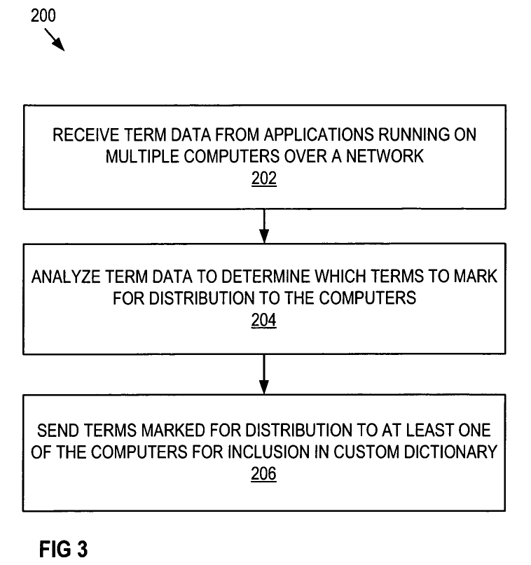

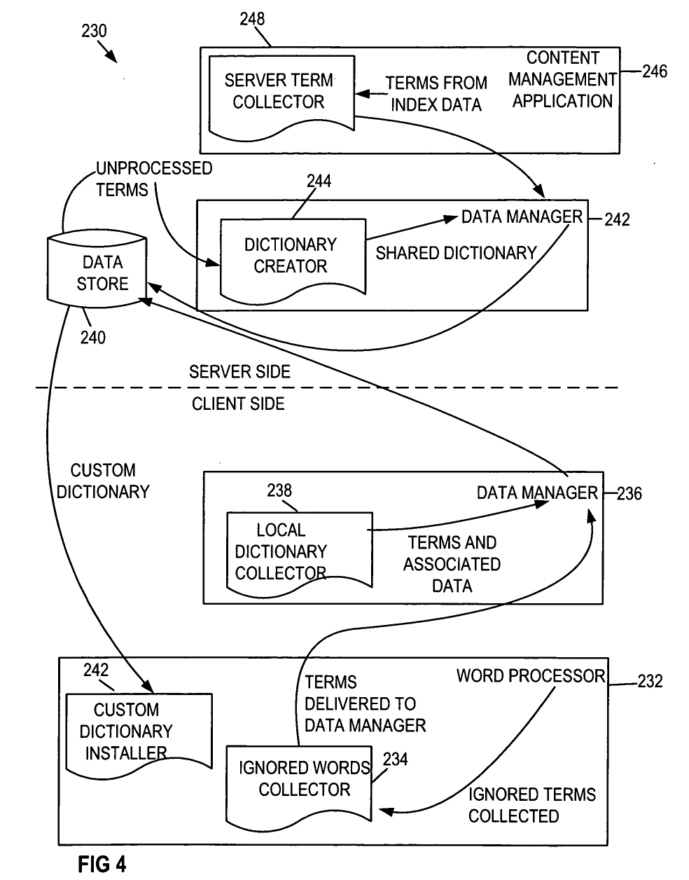

FIG. 3 is a process flow diagram 200 that illustrates one implementation of the high level stages involved creating and distributing a custom dictionary. Term data is received from applications running on multiple computers over a network (stage 202). These applications can be word processing programs, spreadsheet programs, email programs, etc. The term data is analyzed to determine which terms to mark for distribution to the computers (stage 204). In other words, terms that are used frequently enough across the multiple computers to indicate that they may be a common term that everyone in the company may want included in their dictionary can be marked for distribution. The terms that are marked for distribution are sent to at least one of the computers for inclusion in a custom dictionary (stage 206). A more detailed implementation of how a custom dictionary can be created and distributed is shown in FIG. 4, which is discussed next.

FIG. 4 is a diagrammatic view 230 of a custom dictionary distribution system of one implementation. In the example shown, a word processor 232 has an ignored words collector 234 that is operable to collect terms that were suggested as incorrect by a proofing tool, but marked as acceptable by the end user. These ignored words that are actually correct are sent to the data manager 236. A local dictionary that is contained on that user computer is also submitted to the data manager 236. The ignored terms that were actually correct and the local dictionary data are submitted to the data store 240 on the server. In other words, the server can receive actual local dictionaries from one or more computers. Alternatively or additionally, term data could be collected from an email program or other programs.

In one implementation, a custom dictionary could be created from this data gathered from multiple client computers. In the implementation shown in FIG. 4, however, there is more that goes into creating the custom dictionary. In this implementation, additional behavior data is also gathered from a server application to further refine the custom dictionary. For example, behavior data is also collected from a content management application 246 through a server term collector 248. This can include terms that were used in search queries and/or other documents in the content management application 246. These terms collected from content management application 246 are submitted to data manager 242, and then stored in data store 240.

A dictionary creator 244 (which is a data collector) on the server side then analyzes the terms that have been collected from both the client side and the server side to create a list of terms that are marked for distribution to a custom dictionary. This analysis can include analyzing how frequently those terms were used by multiple users across the network, and/or other analysis. The analysis can also include identifying and storing synonyms to those words that are marked for distribution.

In one implementation, dictionary creator 244 simply identifies the terms that need to be distributed across one or more custom group dictionaries on the respective computers and then allows each respective computer to add those terms to its local dictionary. In another implementation, dictionary creator 244 actually creates a revised custom dictionary and distributes an actual custom dictionary file to the respective computers that request it. In this latter example, a custom dictionary installer 242 requests from the data store 240 the terms that have been sent to the data store 240 for inclusion in a custom dictionary. The custom dictionary installer 242 then takes the data and converts it into a custom dictionary that the word processor can load. Then, the next time the client user starts a word processing session, that custom dictionary is loaded that has terms that were aggregated from across many machines over the network.

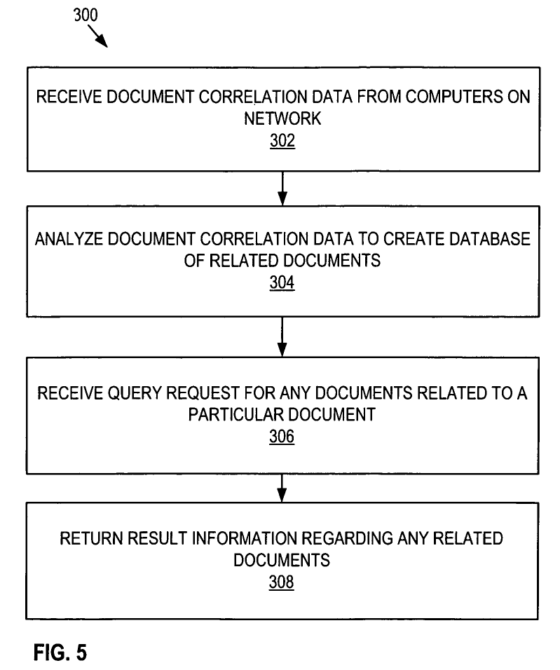

Turning now to FIG. 5, a process flow diagram 300 is shown that illustrates one implementation of the high level stages involved in collecting and distributing related document data. Document correlation data is received from computers over a network (stage 302). For example, documents that are opened around the same time and/or that are often referenced together can get marked as related. The document correlation data is analyzed to create a database of related documents (stage 304).

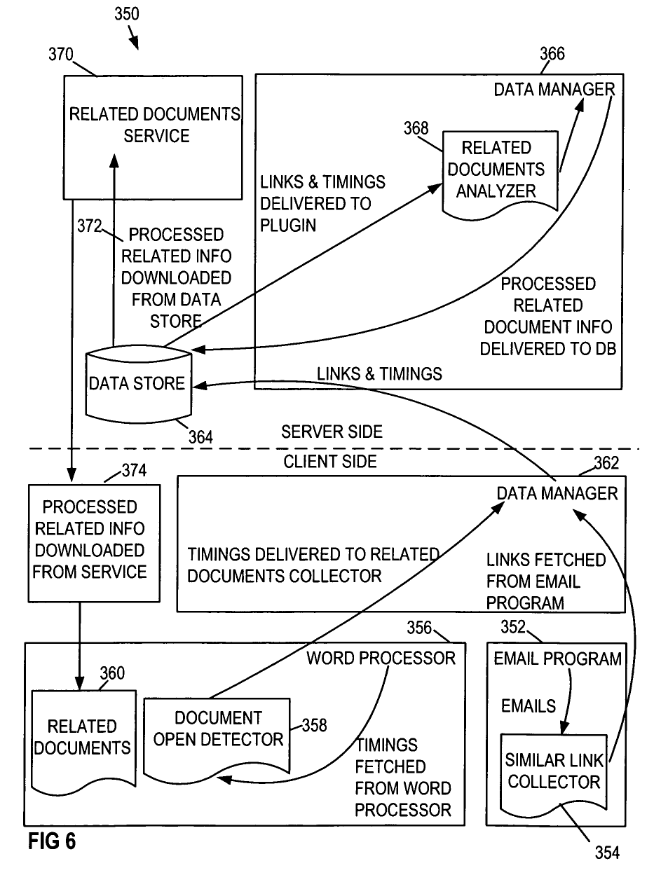

A query request is later received for any documents that are related to a particular document (stage 306). For example, a word processing application or other application may request information about any other documents that are related to a document that the user is currently accessing. This can be requested specifically by the user who wants to see related documents, or this can be requested automatically by an application so that the application can display those related documents automatically. The result information regarding any related documents is returned to the application that requested the information (stage 308). An example of this will be described in further detail in FIG. 6.

FIG. 6 is a diagrammatic view 350 of a related document distribution system of one implementation. In the example shown, an email program 352 collects information about documents that are related to one another through a similar link collector 354. For example, if hyperlinks or embedded attachments to certain documents are often referenced together, then those documents may be gathered by similar link collector 354 as being documents that are related to one another. The similar link collector submits this collected data to data manager 362.

A word processor can have a document open detector 358 which tracks which documents get opened around a similar time. This data is also sent to data manager 362 for inclusion as a possibly related document. This data is then saved in a data store 364. A related documents analyzer 368 then analyzes this collected behavior data and determines in the aggregate which of the documents are actually related to one another. Various techniques can be used to create a web of related documents, such as using temporal analysis, frequency analysis, and/or other heuristics. The data store 364 is then updated with the results of the analysis so the related documents can later be retrieved.

When an application such as word processor 356 requests the related documents 360 that are related to a particular document, then a related documents service 370 is called. The request can include the name or other identifier of a particular document that related document information is being requested for. Related documents service 370 can be implemented as a web service, as an executable, or in any other format that allows the related document data to be accessed from one or more client computers. The related documents service 370 then processes the related information 374 that it accesses from the data store 364 using the document identifier.

The related documents service 370 then submits that information back to the client computer 374 and then to the word processor 356 for display. The result information that is returned back to the word processor 356 can be in the format of one or more identifiers that can then be used to retrieve the actual underlying related documents when desired. For example, these identifiers can be a file path and/or a URL to where that document is located. As another non-limiting example, the result information can include the contents of the related documents themselves (i.e. the actual document itself).

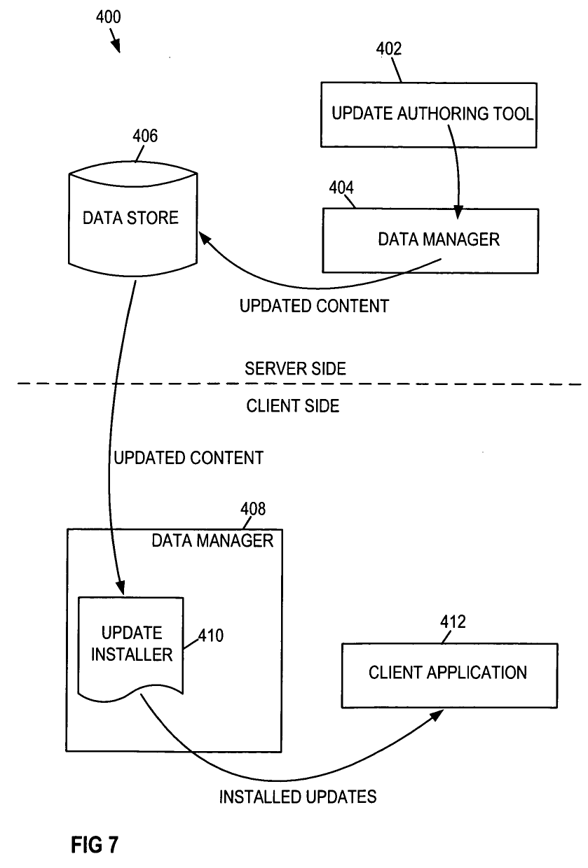

In another implementation, some or all of the techniques described herein can be used for distributing updates to multiple computers over a network. FIG. 7 is a diagrammatic view 400 of a distributed update system of one implementation. For example, system 400 can be used to allow updated content that is created by an administrator to then be distributed to clients within an intranet or other network. First, an update authoring tool 402 is used. The update is then published by sending it from a data manager 404 to the data store 406 with a unique identifier. An update installer 410 of data manager 408 on client machine(s) requests the latest version of the data from the data store 406. The data is unpacked and installed in the local machine. The specific mechanism and installation are dependent on the purpose of the update. The client application(s) can then use the newly installed update to provide fresh content to the user.

As shown in FIG. 8, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 8 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 8 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A data aggregation system comprising:
a data collector that is operable to collect behavior data over a network from one or more applications used by a plurality of computers, and is further operable to save the behavior data to a data store; and
a data installer that is operable to access the behavior data in the data store and convert the behavior data into a format that will modify a future operation of at least one of the applications that is used on at least one of the computers.

2. The system of claim 1, wherein the data collector is further operable to aggregate data that exists in an existing document collection of a server and include the aggregated data as part of the behavior data in the data store.

3. The system of claim 1, wherein the behavior data includes data about which documents were opened on one or more of the computers at a similar point in time.

4. The system of claim 1, wherein the behavior data includes content that one or more users of the computers typed into documents.

5. The system of claim 4, wherein at least some of the content included in the behavior data includes multiple document hyperlinks that were contained together within one or more emails.

6. The system of claim 1, wherein the format is a dictionary that can be used by word processors on one or more of the computers.

7. The system of claim 1, wherein the format is a list of related documents that can be displayed within one or more of the applications on the computers.

8. The system of claim 1, wherein the format is a list of related people that can be displayed within one or more of the applications on the computers.

9. The system of claim 1, wherein the format includes an updated version of one or more of the applications.

10. A method for creating and distributing a custom dictionary comprising the steps of:
receiving term data from a plurality of computers over a network, the term data including terms that have been collected from applications running on the computers;
analyzing the term data that was received from the computers to determine which terms should be marked for distribution to the computers; and
sending the terms marked for distribution to at least one of the computers for inclusion in a custom dictionary that is used by one or more of the applications.

11. The method of claim 10, wherein at least some of the term data is collected from one or more custom dictionaries uploaded from one or more of the computers.

12. The method of claim 10, wherein at least some of the term data is collected as one or more words that were initially flagged as incorrect by a proofing tool in one or more of the applications, with those one or more words having then being designated as acceptable by a particular user.

13. The method of claim 10, wherein the analyzing step includes determining how frequently a certain term was being used on the computers.

14. The method of claim 10, wherein the analyzing step includes analyzing emails to determine which terms should be marked for distribution to the computers.

15. The method of claim 10, further comprising the steps of:
identifying synonyms of the term data and including the synonyms as part of the terms marked for distribution.

16. The method of claim 10, wherein at least one of the applications is a word processing application.

17. A method for identifying related documents comprising the steps of:
receiving document correlation data from a plurality of computers over a network, the document correlation data including information about documents that were opened at similar points in time;
analyzing the document correlation data that was received from the computers to create a database of related documents;
receiving a query request from one the computers over the network, the query request containing a request for any documents that are related to a particular document; and
in response to the query request, returning result information regarding one or more documents that are contained in the database of related documents that were previously determined to be related to the particular document.

18. The method of claim 17, wherein the document correlation data also includes information about documents that are referenced together in emails.

19. The method of claim 17, wherein the result information that is returned contains one or more identifiers that can be used to retrieve the one or more documents that were determined to be related to the particular document.

20. The method of claim 17, wherein the result information that is returned includes actual contents of the one or more documents.
